(19) United States
(12) Patent Application Publication
(10) Pub. No.: US 2011/0273709 A1
(43) Pub. Date: Nov. 10, 2011

(54) Spectrophotometer

(75) Inventor: Stephen John Sweeney, Eastbourne (GB)

(73) Assignee: ZINIR LIMITED, Eastbourne (UK)

(21) Appl. No.: 13/143,089

(22) PCT Filed: May 5, 2010
(86) PCT No.: PCT/GB2010/050737

§ 371 Date: Jul. 1, 2011

(30) Foreign Application Priority Data
May 8, 2009 (GB) GB0908027.6
Mar. 8, 2010 (GB) GB1003863.6
May 4, 2010 (GB) GB1007417.7

(51) Int. Cl. G01J 3/42

(52) U.S. Cl. 356/320; 356/319

(57) ABSTRACT

A spectrophotometer comprising a monolithic semiconductor substrate, one or more wavelength dispersing means, and one or more wavelength detecting means, wherein the monolithic substrate (1) has waveguide means (2) and one or more resonators (3-14) acting as detectors of particular light wavelengths and disposed in proximity to the waveguide means in such a way that evanescent light coupling can occur for said light wavelengths.

### TECHNICAL FIELD

This invention relates to a device to identify and quantify a substance, and more particularly the present invention relates to a spectrophotometer in which there is no physical separation between the light dispersion means and the light detection means. In addition the invention also relates to a spectrophotometer with no moving parts.

### BACKGROUND ART

Spectrophotometry is the study of electromagnetic spectra. Spectrophotometry involves the use of a spectrophotometer. A spectrophotometer is a photometer; a device for measuring light intensity, that can measure the intensity of light as a function of the wavelength of light. Such spectrophotometers are used in many fields such as chemistry, biology, forensic sciences, space and earth observation, security and many types of industries. Spectrophotometers have additional broad applications for example in colour identification in flat panel displays or electronic cameras, colour control for xerographic printing, environmental monitoring, and process controls which are related to colour/wavelength identification.

The most common application of spectrophotometers is the measurement of light absorption, but spectrophotometers can be designed to measure, for example, diffuse reflectance, transmission or the emission spectrum of materials or devices. Spectrophotometers may in principle operate over the entire wavelength range of the electromagnetic radiation spectrum of light. However, most spectrophotometers operate in the visible, infrared, near infrared, mid-infrared or ultraviolet wavelength ranges of the electromagnetic spectrum. The wavelength region and the range of a spectrophotometer is determined in part by the spectral data that the spectrophotometer is designed to gather, and the type of light dispersion and light detection systems used. This in turn puts limitations on the acquisition speed, sensitivity and resolution capabilities of the spectrophotometer.

Conventional spectroscopic systems can be classified in two categories; (a) dispersive systems and (b) interferometric (FTIR) systems. In both cases the basic system consists of a mechanism by which the light is dispersed (either spectrally or temporally) with a grating or linear drive mechanism, plus a detection element (usually a semiconductor based photodetector or photo-multiplier tube). Thus, such systems consist of a minimum of two parts. In practice such systems require multiple additional optical elements such as lenses, mirrors, shutters, slits and optical choppers in order for the spectrophotometer to function efficiently. Historically, spectrophotometers use a monochromator to analyse the spectrum, but there are also spectrophotometers that use arrays of photosensors such as CCD arrays. Such systems are for example shown in GB 0525408.1. Such spectrophotometers are complex due to the number of parts. These systems often contain mechanical grating monochromators to disperse the light, slits, baffles and cooled photodetectors, lenses mirrors and shutters which all have to be correctly aligned for the spectrophotometer to function properly. These systems are prone to malfunction due to the complexity and large number of parts, have relatively slow acquisition times, are expensive to produce and have problems associated with stray light, as each additional component introduced into an optical system, creates a loss of photons and so reduces signal intensity. This problem is compounded when there is large spatial separation between the components of the spectrophotometer which comprise the light dispersion and light detection components (optical path). Furthermore, array based spectrometers suffer the additional disadvantage of having their optical properties fixed so that, for example, it is not possible to increase spectral resolution or sensitivity by altering the width of a slit as is possible in conventional grating based spectrometers.

In addition, in stringent applications, such as those where the spectrophotometer is required to be portable these systems are not ideal as they are heavy, large in size and are prone to malfunction due to damage or misalignment of the optical path, by stress damage etc. This is exacerbated when the system is used in space, aerial or other harsh environment applications in that traditional FTIR and grating based instruments with their mechanically driven moving parts are fragile instruments that do not cope well with vibrational stresses and the stresses of launch, the space vacuum and extremes of temperature. Mass and size are an additional drain on resources allocated to payload. CCD arrays for the visible region when used in a spectrophotometer reduce the pressure on energy resources somewhat but can be affected by cosmic radiation and are susceptible to alignment error.

Many additional applications of interest arise if spectrophotometers were significantly lower cost, lighter weight, smaller size, rugged, and incorporated signal processing capability in the instrument.

To overcome some of these disadvantages the art has developed miniaturised spectrophotometry systems, for example microelectromechanical systems (MEMS) such as that of U.S. Pat. No. 7,106,441 entitled ‘Structure and method for a microelectromechanic cylindrical reflective diffraction grating spectrophotometer’, that discloses a tunable MEMS spectrophotometer with a rotating cylindrical reflective diffraction grating that is integrated with a photodetector and an optical fibre light source on a Rowland circle on a monolithic silicon substrate.

Other examples include spectrophotometers disclosed in US2008198388 which describes a miniature Fourier transform spectrophotometer having a moving scanning mirror; US2006132764 describing an integrated optics based high resolution spectrophotometer having an arrayed waveguide grating coupled to a photodetector; US2004145738 describes a MEMS spectrophotometer with a rotating grating; DE10216047 describes a multiple reflection optical cell having an internal sample holding cavity, a light entry port, and a light exit port that is free of moveable mirrors or other moveably linked optical components. The reflecting surfaces of the cell may take the form of opposed parabolic or parallel pairs, cylindrical, circular or spiral arrangements of multiple minors; and U.S. Pat. No. 6,249,346 describes a micro spectrophotometer that is monolithically constructed on a silicon substrate. This spectrophotometer comprises a concave grating, which is used for dispersing optical waves as well as focusing reflected light onto a photodiode array sited on a silicon bridge.

All of the above spectrophotometer approaches overcome some of the above identified problems in that they afford a reduction in the size of a spectrophotometer, they all however suffer from the disadvantages that they either have one or more moving parts, are not unitary in construction or are complex in their construction, or have poor light dispersion properties and resolution due to miniaturisation. Thus, these technologies do not fully address the problems described above in that they are prone to failure, have problems with stray light and are generally expensive and difficult to produce, or have poor light dispersion properties and resolution due to miniaturisation.

To overcome some of these disadvantages other kinds of spectrophotometers have been developed These include for example U.S. application Ser. No. 11/015,482 entitled ‘Integrated optics based high resolution spectrophotometer’; WO2007072428 entitled ‘Spectrophotometer and spectrophotometric processing using Fabry-Perot resonators’; Japanese Patent Application Number JP1990128765 entitled ‘Multiple-wavelength spectrophotometer and photodiode arrayed photodetector’; U.S. Pat. No. 6,785,002 entitled ‘variable filter based optical spectrometer’; U.S. Pat. No. 6,249,346 entitled ‘Monolithic spectrophotometer’; U.S. patent application Ser. No. 11/206,900 entitled ‘Chip-scale optical spectrum analyzers with enhanced resolution’. All the above prior art utilise separate components for light dispersion and detection leading to issues during fabrication and performance degradation.

All of the spectrophotometer above still have separate monochromator and detection optics meaning that on a miniature scale they will lack resolution (due to the limited spatial separation between the dispersion and detection elements), are difficult to fabricate (due to the need for accurate alignment) and have issues relating to the effect of stray light (since intense light may readily scatter within the spectrophotometer).

Disk resonators, also known as micro disk resonators, or resonators are known in the art for the addition and removal of specific wavelengths from a fibre optical cable in telecommunications. Examples of disk resonators include U.S. patent application Ser. No. 10/323,195 entitled ‘Tuneable optical filter’ which describes a tunable filter having a resonator with a resonator frequency dependent upon a variable gap is provided. Although this application describes an optical filter it is not used for detection; Optical Express, 2006, vol 14, no 11, p 4703-4712 (Lee and Wu) entitled ‘Tuneable coupling regimes of silicon micro disk resonators using actuators’. This paper describes tunable coupling regimes of a silicon micro disk resonator controlled by MEMS actuation. This disclosure describes a tunable optical filter requiring MEMS moving parts to function and the micro disk are not used for detection; U.S. patent application Ser. No. 10/678,354 entitled ‘ultra-high Q micro-resonators and methods of fabrication’ describes a micro cavity resonator including a micro cavity capable of high and ultra-high Q values and a silicon substrate. This application describes a tunable optical filter but does not envisage a means for use of detection or dispersion; Applied Physics Letters, 2002, vol 80, no 19, p 3467-3469 entitled ‘Gain trimming of the resonator characteristics in vertically coupled InP micro disk switches’ describes a vertically coupled micro disk resonator/waveguide switches device that exhibits a single mode operation. This invention describes an optical switch for use in communications applications. The resonators are not used for detection.

The prior art described above is all in the field of telecommunications where the disk resonators are used to direct/divert/add or remove specific wavelength from an optical fibre or waveguide. None of the prior art above considers using micro disk resonators for detection, spectroscopy, as a monochromator or even as a detector of the intensity of light at that wavelength.

### DISCLOSURE OF INVENTION

### Technical Problem

The art has identified several problems within the art of spectrophotometers, these problems are described above. Such spectrophotometers are complex due to the number of parts. These systems often contain mechanical grating monochromators to disperse the light, slits, baffles and cooled photodetectors, lenses minors and shutters which all have to be correctly aligned for the spectrophotometer to function properly. These systems are prone to malfunction due to the complexity and large number of parts, have slow acquisition times, are expensive to produce and have problems associated with stray light, as each additional component introduced into an optical system, creates a loss of photons and so reduces signal intensity.

Furthermore, array based spectrometers suffer the additional disadvantage of having their optical properties fixed so that, it is not possible to increase spectral resolution or sensitivity by altering the width of a slit as is possible in conventional grating based spectrometers. Often these systems are heavy and therefore not suitable for portable applications.

MEMS systems overcome some of these disadvantages. However these systems suffer from the disadvantages that they either have one or more moving parts, are not unitary in construction or are complex in their construction, or have poor light dispersion properties and resolution due to miniaturisation. Thus, these technologies do not fully address the problems described above in that they are prone to failure, have problems with stray light and are generally expensive and difficult to produce, or have poor light dispersion properties and resolution due to miniaturisation.

To overcome these disadvantages chip based components have been used. However all of the spectrophotometer approaches described above have separate monochromator and detection optics meaning that on a miniature scale they will lack resolution (due to the limited spatial separation between the dispersion and detection elements), are difficult to fabricate (due to the need for accurate alignment) and have issues relating to the effect of stray light (since intense light may readily scatter within the spectrophotometer).

Therefore the prior art does not address the identified problems.

### Technical Solution

It is therefore an object of the present invention to provide a spectrophotometer which addresses one or more of the above identified problems. Specifically this invention relates to a spectrophotometer comprising a monolithic semiconductor substrate (1), one or more wavelength dispersing means (3-14), and one or more wavelength detecting means (3-14), characterised in that there is no physical separation between the dispersing means (3-14) and detecting means (3-14).

### Advantageous Effects

Advantageously such a spectrophotometer would have little loss of input photons and a high signal to low noise ratio, and thus would have an improved signal intensity.

Accordingly, an embodiment of the present invention also provides a spectrophotometer with no physically moving parts.

Advantageously such a spectrophotometer would result in a system which is not complex, would be low maintenance, has no grating-detector alignment problems or stray light issues. Such a system would also result in a spectrophotometer with a fast acquisition time and high resolution.

In a preferred embodiment the spectrophotometer comprises a monolithic substrate, characterised in that the monolithic substrate (1) is a semiconductor having a one or more waveguide means (2) and one or more resonators (3-14) wherein each resonator (3-14) forms part of the waveguide means (2), or each resonator (3-14) is optimally positioned in proximity to the waveguide means (2).

Advantageously, a spectrophotometer of this type, without moving parts of the type described can be manufactured to have the following properties.

The spectrophotometer can be manufactured to be small in size. Such a spectrophotometer could therefore find new utility as part of for example a mobile phone or other device capable of conveying information from the spectrophotometer (mounted within or on the surface of the mobile phone) from a remote position, thereby allowing a network of mobile or static chemical sensors to be developed. Such a small size sensor would also find utility in spectrophotometers where weight or size is undesirable for example in space applications. For example in xerographic printing, a spectrophotometer could be a key component in a closed-loop colour control system which will enable the printers to generate reproducible colour images in a networked environment. In a camera the spectrophotometer chip could be used to replace currently available light sensitive chips to produce a camera capable of detecting light over the entire visible range, as opposed to only detecting discrete ranges of light.

The spectrophotometer described has a low power requirement. Advantageously such a spectrophotometer would find utility in portable spectrophotometers or spectrophotometers which are not connected to a mains power supply.

Advantageously such a spectrophotometer would allow fast acquisitions of data as all wavelengths of light would be read simultaneously. Therefore the entire spectra can be read in milliseconds or less.

Advantageously such a spectrophotometer would have superior spectral properties as such a spectrophotometer would have low stray light and therefore produce high resolution spectra. In addition such a spectrophotometer could be manufactured to have very high resolution and wide wavelength coverage.

Advantageously such a spectrophotometer would be cheaper to produce than those currently on the market as the spectrophotometer does not have moving parts, gratings, MEMS etc.

Advantageously such a spectrophotometer would have no moving parts. Therefore, the spectrophotometer would not suffer from failure due to moving part failure. Such a spectrophotometer would be more rugged and reliable than spectrophotometers currently on the market.

In a preferred embodiment the spectrophotometer comprises a monolithic substrate, characterised in that the monolithic substrate (1) is a semiconductor having one or more waveguide means (2) and one or more resonators (3-14) wherein the waveguide may be angled in relation to the incidence of input light, wherein each resonator (3-14) forms part of the waveguide means (2), or each resonator (3-14) is optimally positioned in proximity to the waveguide means (2), the resonators are optimally dimensioned for a given electromagnetic wavelength, and ordered such that the smallest diameter resonator is closest to the point of entry of incoming light into the waveguide means, and the largest diameter resonator is furthest away from the point of entry of incoming light into the waveguide means, the substrate is divided into three functional regions, wherein the first region is a substrate layer (17) made from a semi-conductor doped either p- or n-type, the second active region (16) comprising of a semi-conductor in which a band gap is incorporated to cover the wavelength range of the spectrophotometer and has a refractive index greater than that of the substrate, and the third optical cladding region (18) having a lower refractive index than the second active region (16), wherein the second active region (16) is positioned between the first active region (17) and the third active region (18) the third region (18) is a common electrical contact with the first region (17), and the resonators (3-14) have electrical contacts (19, 20) on their surfaces.

### DESCRIPTION OF DRAWINGS

Embodiments of the present invention will now be described in more detail, by way of example only, with reference to and as illustrated by FIGS. 1 to 4 of the accompanying drawings of which:

FIG. 1: Concept of spectrophotometer

FIG. 2: two cross-sections through the semiconductor chip [1] corresponding to those indicated by A and B in FIG. 1.

FIG. 3: Three dimensional representations of the semiconductor chip showing resonators (3-18) coupled with the waveguide (2) either horizontally (A) or vertically (B).

FIG. 4: Epitaxial design for a typical spectrometer chip working in the NIR region and designed with horizontally aligned resonators as depicted in FIG. 3A.

It should also be noted that certain aspects of the drawings are not to scale and that certain aspects are exemplified or omitted to aid clarity.

### BEST MODE

This invention will be exemplified by reference to its most preferred embodiments. However, the invention is not limited to said embodiments.

This invention relates to a spectrophotometer in which there is no physical separation between the light dispersing means and the light detecting means, such a spectrophotometer having no moving parts. For the reasons given above, the inventors have found that some spectrophotometers which have moving parts are prone to failure or cannot be miniaturised or are expensive/difficult to manufacture or have other associated problems.

It is therefore an object of the present invention to provide a spectrophotometer having no moving parts. Accordingly, an embodiment of the present invention provides a spectrophotometer comprising a monolithic semiconductor substrate (1), one or more wavelength dispersing means (3-14), and one or more wavelength detecting means (3-14), characterised in that there is no physical separation between the dispersing means (3-14) and detecting means (3-14). It is envisaged that such a spectrophotometer would also have no moving parts. Advantageously a spectrophotometer of the type described can be manufactured to have the following properties.

The spectrophotometer can be manufactured to be small in size. Such a spectrophotometer could therefore find new utility as part of for example a mobile phone or other device capable of conveying information from the spectrophotometer (mounted on the surface of the mobile phone) from a remote position, thereby allowing a network of mobile or static chemical sensors to be developed. Such a small size sensor would also find utility in spectrophotometers where weight or size is undesirable. For example in xerographic printing, a spectrophotometer could be a key component in a closed-loop colour control system which will enable the printers to generate reproducible colour images in a networked environment. In a camera the spectrophotometer chip could be used to replace currently available light sensitive chips to produce a camera capable of detecting light over the entire visible range, as opposed to only detecting discrete ranges of light.

### Mode for Invention

The spectrophotometer described below would have a low power requirement. Advantageously such a spectrophotometer would find utility in portable spectrophotometers or spectrophotometers which are not connected to a mains power supply or operate in difficult environments such as for example space, aeronautics, defence etc.

Advantageously such a spectrophotometer would allow fast acquisitions of data as all wavelengths of light would be read simultaneously. Therefore the entire spectra could be read in milliseconds or less.

Advantageously such a spectrophotometer would have superior spectral properties as such a spectrophotometer would have low stray light and therefore produce high resolution spectra. In addition such a spectrophotometer could be manufactured to have very high resolution and wide wavelength coverage.

Advantageously such a spectrophotometer would be cheaper to produce than those spectrophotometers currently on the market as this spectrophotometer does not have moving parts, gratings, MEMS etc.

Advantageously such a spectrophotometer would have no moving parts. Therefore, the spectrophotometer would not suffer from failure due to moving part failure. Such a spectrophotometer would be more rugged and reliable than spectrophotometers currently on the market.

Optionally the waveguide of the spectrophotometer may be angled in relation to the incidence of light to prevent back reflection of light.

Optionally, the waveguide of the spectrophotometer may be between about 1 micron and about 50 microns wide, about 1000 microns long and about 1 micron and about 20 microns deep.

In a preferred embodiment each resonator is dimensionally optimised for a given electromagnetic wavelength and each resonator can be cylindrical, cupped, spherical, conical, stepped conical, tabulate or comprises one or more flat or curved surfaces. In a most preferred option each resonator is spherical, cylindrical or cupped in shape and the diameter of each sphere or cylinder is determined by the formula D=nλ/πμ where λ is the free space wavelength of the light, n is the resonance order and μ is the effective refractive index of the resonator.

Optionally the waveguide means may be formed from resonators (3-14) arranged such that the resonators (3-14) are arranged in a linear manner, wherein the resonators are arranged from small to large such that the smallest resonator is positioned at the first position and the largest resonator is positioned at the last position. In a preferred embodiment the resonators are ordered such that the smallest diameter resonator is closest to the point of entry of incoming light into the waveguide means, and the largest diameter resonator is furthest away from the point of entry of incoming light into the waveguide means.

Alternatively compositional grading or doping of the absorbing layers may be used instead of or in addition to resonator size to select specific wavelengths for each resonator. A set of resonators with identical diameter could be used and the resonance changed by manipulating the refractive index. For example, for resonators with diameters ˜1 micrometre, by compositional/doping (with impurities) grading a total index step of <0.02 across 10 resonators would produce resonances spaced 1 nm apart, eg from 1500-1510 nm without varying the diameter of the resonators.

Alternatively, the spectrometer chip could use the bias voltage as a means of tuning the refractive index. Thus, part of the chip test could be to determine if the bias voltage on any given resonator could be optimised to move one or more of the resonances. This is also a very good way of altering the resolution of the spectrometer chip on-the-fly.

In a preferred embodiment the resonators work in the first order and only respond to a single wavelength in the spectrometer. Alternative embodiments envisage using resonators which work at a higher order (and are therefore larger and easier to manufacture with sufficient tolerance). When larger resonators are used in the higher order there are three ways in which unwanted wavelengths may be excluded:
1. The absorbing layer is chosen to have a fixed spectral absorption bandwidth of its own, therefore it will not respond to wavelengths above a certain limit
2. Use of a thin film filter on the front of the chip (light input end) may be used to suppress shorter wavelengths which are not of interest but which might couple into and be absorbed by the resonator
3. The waveguide itself will absorb wavelengths below a particular cut-off wavelength and therefore acts as a filter

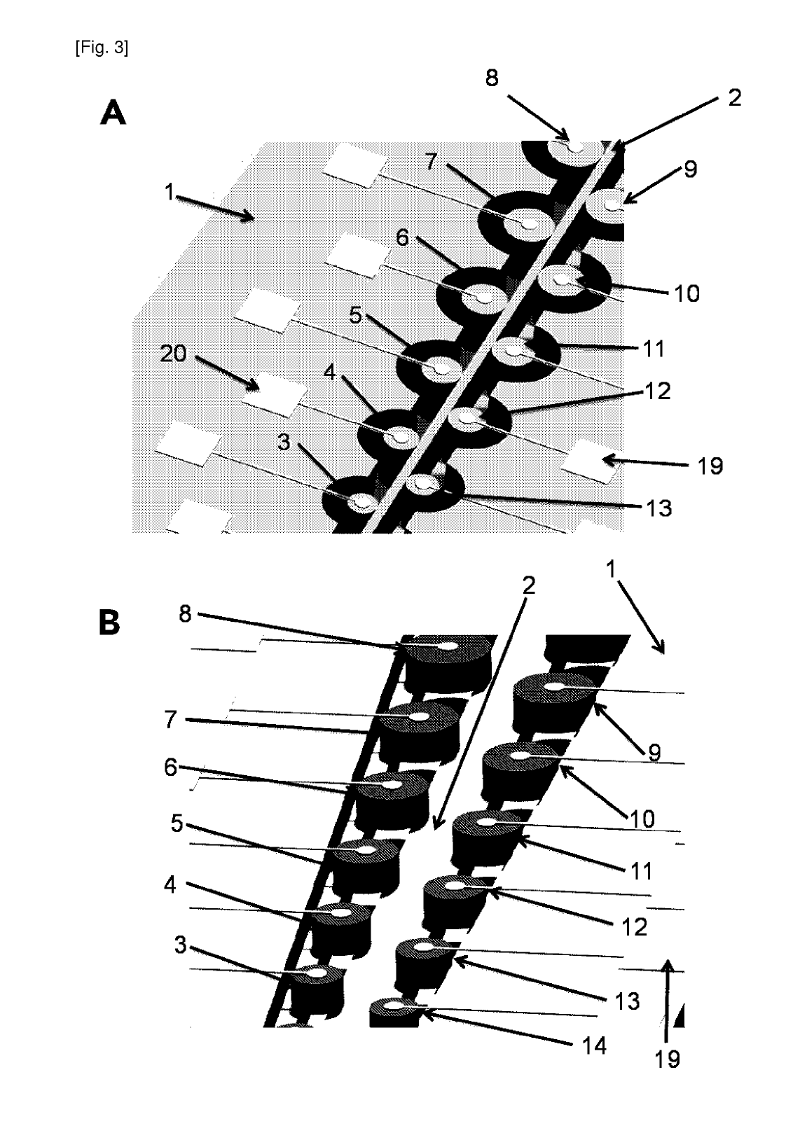

Resonators may be placed horizontally or vertically in relation to the waveguide for horizontal or vertical coupling. FIG. 3B shows an example of vertical coupling in which the resonators straddle two ridges. Such a configuration would be particularly suitable when the resonators are working at high order.

The spectrophotometer is manufactured from a substrate which may comprise a group IV, III-V, II-VI, II-IV or other semiconductor onto which a semiconductor alloy is added. Preferably the substrate is doped either p- or n-type.

In a preferred embodiment the substrate is divided into three functional regions, wherein the first region is a substrate layer (17) made from a semiconductor doped either p- or n-type, the second active region (16) comprising of a semiconductor in which a band gap is incorporated to cover the wavelength range of the spectrophotometer and has a refractive index greater than that of the substrate, and the third optical cladding region having a lower refractive index than the second active region (16), wherein the second active region (16) is positioned between the first active region (17) and the third active region (18). The third region (18) is a common electrical contact with the first region (17). Preferably the electrical contact (18) is a gold electrical contact, a gold alloy electrical contact or an electrical contact made by other conductive materials or compositions thereof, such as for example silver or compositions thereof

Preferably the resonators (3-14) have electrical contacts (19, 20) on their surfaces and these contacts comprise a gold electrical contact, a gold alloy electrical contact or an electrical contact comprising other electrically conductive materials.

Optionally the cleaved facets of the semiconductor wafer may be coated with multilayer coatings to accept or reject light over a particular wavelength range. Such coatings are known to those skilled in the art.

In a further option the substrate may comprise one or more solid state shutters/modulators or light guiding optics.

In a more preferred embodiment, the spectrophotometer comprises a monolithic substrate, characterised in that the monolithic substrate (1) is a semiconductor having a waveguide means (2) and one or more resonators (3-14) wherein the waveguide is angled in relation to the incidence of input light, wherein each resonator (3-14) forms part of the waveguide means (2), or each resonator (3-14) is optimally positioned in proximity to the waveguide means (2), the resonators are optimally dimensioned for a given electromagnetic wavelength, and ordered such that the smallest diameter resonator is closest to the point of entry of incoming light into the waveguide means, and the largest diameter resonator is furthest away from the point of entry of incoming light into the waveguide means, the substrate is divided into three functional regions, wherein the first region is a substrate layer (17) made from a semiconductor doped either p- or n-type, the second active region (16) comprising of a semiconductor in which a band gap is incorporated to cover the wavelength range of the spectrophotometer and has a refractive index greater than that of the substrate, and the third optical cladding region having a lower refractive index than the second active region (16), wherein the second active region (16) is positioned between the first active region (17) and the third active region (18) the third region (18) is a common electrical contact with the first region (17), and the resonators (3-14) have electrical contacts (19, 20) on their surfaces.

Conventional spectroscopic systems can be classified in two categories; (a) dispersive systems and (b) interferometric (FTIR) systems. In both cases the basic system consists of a mechanism by which the light is dispersed (either spectrally or temporally) with a grating or linear drive mechanism, plus a detection element (usually a semiconductor based photodetector or photo-multiplier tube). Thus, such systems comprise a minimum of two parts, a light dispersion means and a light detection means. In practice such systems require multiple additional optical elements such as lenses, mirrors, shutters, slits and optical choppers, an example of which is shown in GB 0525408.1. Furthermore, the output of the spectrometer is connected to signal processing equipment such as lock-in-amplifiers, box-car averagers and other signal conditioning circuitry which allows interpretation of an output signal. Furthermore, the resolution (minimum resolvable wavelength features) scales inversely with the physical size of the unit, thus for high resolution, a large instrument is required. Therefore conventional spectrophotometers that have high resolution have by necessity been large and as a consequence heavy and bulky. This has resulted in the limitation of the use of spectrophotometers. In addition such spectrophotometers are delicate in nature and therefore do not tend to be portable in nature.

This application describes a spectrometer (element) which is based upon a single monolithic semiconductor chip. This element is manufacturable using standard semiconductor fabrication processes. The chip incorporates both the light dispersion and the light detection system in which one or more resonators acts as both the light dispersion means and light detection means. Furthermore, in a particular embodiment the chip may incorporate a shutter/modulator (solid-state) and other light-guiding optics.

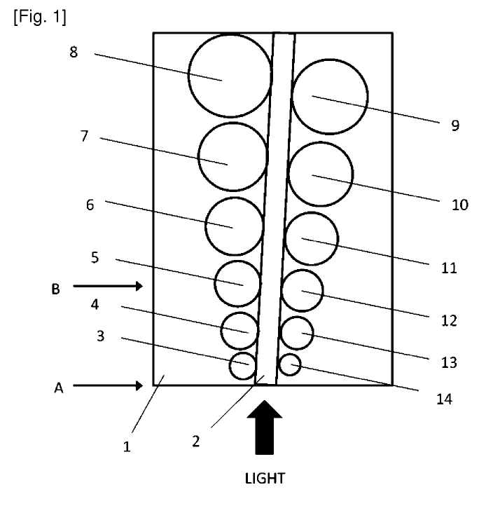

The basic concept is illustrated in FIG. 1. [1] represents the semiconductor chip of typical dimensions 200 microns wide×1000 microns long×100 microns thick. The material comprising the semiconductor chip may comprise of group IV semiconductors, II-IV semiconductors, II-VI semiconductors or any of the following III-V semiconductors of alloys thereof; GaAs, GaN, GaP, GaSb, InAs, InN, InP, InSb, AlAs, AN, AlP and AlSb, the choice of which is determined by the desired wavelength range of the spectrometer chip. Additionally the incorporation of dopant impurities may be used to fine tune the optical and electronic properties of the chip. [2] represents the optical waveguide composed of materials as for [1]. The waveguide is deliberately angled with respect to the semiconductor chip [1] so as to avoid back reflections. The waveguide is typically between 1 and 50 microns wide×1000 microns long×1-20 microns deep. In addition, the end facets of the chip may be coated to accept and/or reject incoming light over particular wavelength ranges. [3-14] are representative examples of the circular resonators of which there may be any number. A higher number of resonators will provide a wider wavelength range and/or higher spectroscopic resolution. A typical embodiment would typically incorporate 10-1000 resonators on a single chip. The dimension of the resonator is chosen such that the diameter (D) of the resonator is equal to the wavelength of interest (λ) multiplied by the resonance order (n) divided by n and the refractive index (μ) of the semiconductor comprising the resonator (i.e. D=nλ/πμ). Thus for detecting light at a wavelength of 1.55 microns requires a resonator with a diameter of 0.164 microns assuming a semiconductor with a refractive index of 3 operating in first order (n=1). Larger disks operating for n>1 may also be fabricated (e.g. for n=10, D=1.64 microns) providing that the light is pre-filtered to remove other orders forming resonances within the microdisk. The resonators are ordered with the smallest diameter resonators closet to the point of entry of the incoming light, as shown in FIG. 1. The resonance may also be controlled via the refractive index, μ, which may be changed by varying the alloy composition and/or by introducing dopant impurities into the resonators.

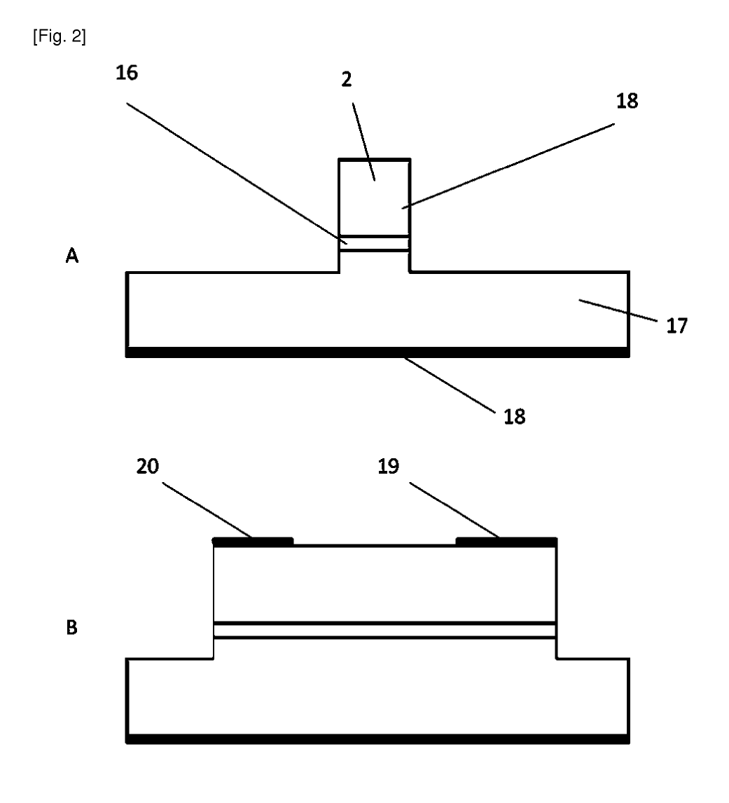

FIG. 2 illustrates two cross-sections through the semiconductor chip [1] corresponding to those indicated by A and B in FIG. 1. [17] of FIG. 2A represents the substrate material made of the materials listed as for [1] and doped either n- or p-type. The substrate is typically ˜90 microns in thickness and is used as the template for the spectrometer chip. Atop the substrate an active region [16] is grown (typically by Molecular Beam Epitaxy or Metal-Organic Vapour Phase Epitaxy consisting of a semiconductor as per [1] but for which the band gap is designed to cover the target wavelength range of the spectrometer and which has a refractive index greater than that of the substrate. The band gap (E_{g}) of the semiconductor is chosen so as to determine the maximum detection wavelength of the resonator, where λ=hc/E_{g} where h is the Planck constant and c is the velocity of light in a vacuum, which may be approximated as λ(nm)=1240/E_{g}(eV). In the case of low dimensional structures such as quantum wells, quantum wires or quantum dots, the thickness of the absorbing semiconductor layer in the resonator is chosen such that λ(nm)=1240/(E_{g}+Eₑ+Eₕ) (eV) where Eₑ is the electron confinement energy and Eₕ is the hole confinement energy. [18] is the upper optical cladding layer which comprises semiconductor material as per [1] and chosen to have a larger band gap and lower refractive index than layer [16]. [18] represents an electrical contact common to the lower surface of the device, typically made from gold and alloys thereof. [19] and [20] illustrate electrical contacts made directly to the upper surface of the resonators, typically made from gold and alloys thereof. Resonators can be placed along the waveguide in any order. However, the optimal positioning is for the smallest diameter resonator to be placed closest to the light entrance on the resonator and the largest being placed further away. Resonators between the first and last resonators increase sequentially in diameter.

FIG. 3A provides a topological illustration of a particular embodiment where the resonators [3-13] and waveguide [2] are defined through etching of a semiconductor structure grown atop a substrate. Electrical contacts are provided via evaporated and/or sputtered conductors and contact pads, for example as in [19,20]. In this embodiment, the optical coupling is horizontal between the waveguide [2] and the resonators [3-13]. FIG. 3B illustrates an alternative embodiment where the light is coupled from the waveguide [2] into the resonators [3-14] whereby the resonators are defined through etching above the waveguide. Electrical contacts are provided via evaporated and/or sputtered conductors, and example of which is labelled as [19].

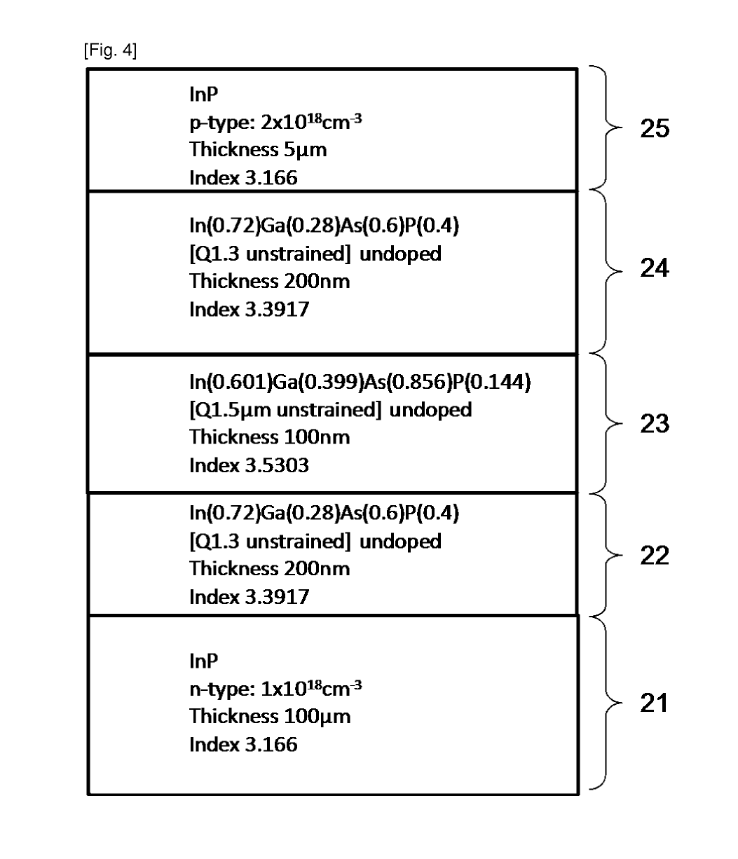

FIG. 4 shows a typical epitaxial structure for a specific embodiment as illustrated in FIG. 3A of the concept targeting a device operating around 1.5 μm. The chip is grown on an InP substrate doped n-type to a concentration of 1×10¹⁸ cm⁻³ and post-thinned to a thickness of approximately 100 μm [21]. Onto this, an In(0.72)Ga(0.28)As(0.6)P(0.4) layer is grown of thickness 200 nm with optical band gap equivalent to 1.3 μm [22], then an In(0.601)Ga(0.399)As(0.856)P(0.144) layer of thickness 100 nm and optical band gap 1.5 μm [23]. This is followed by a second In(0.72)Ga(0.28)As(0.6)P(0.4) layer of thickness 200 nm with optical band gap equivalent to 1.3 μm [24] followed by a p-type InP layer of thickness 5 μm doped to a concentration of 2×10¹⁸ cm^{-3[25}]. In this embodiment, the input light is guided in the waveguide ([2] and [22-24] between the top [25] and bottom [21] InP layers, travelling predominantly through the 1.3 μm In(0.72)Ga(0.28)As(0.6)P(0.4) layers [22, 24]. The top InP [25] and In(0.72)Ga(0.28)As(0.6)P(0.4) layer [24] are selectively etched in the resonator region where the In(0.601)Ga(0.399)As(0.856)P(0.144) layer [23] forms the absorbing layer providing absorption at and below 1.5 μm. Other epitaxial structure embodiments are envisaged and known in the art.

Operating Principles

This invention differs from the prior art in at least three ways;
1. (a) No physical separation between the light dispersion means and the light detection means,
2. (b) use of a series of resonators to disperse light over a wavelength range, and
3. (c) use of a series of resonators to detect levels of light at particular wavelengths.

The light emanating from the point of interest enters the device as shown by the arrow in FIG. 1. The incident surface of the chip may be coated to reject/select wavelengths of interest—a pre-filter. The entrance point may also include an electroabsorption modulator to optically isolate the chip at any given time. Due to the refractive index difference between the waveguide [2] and its surroundings, the light is channeled along the waveguide. The electric field distribution of the light (the optical field distribution) is typically Gaussian in profile decaying laterally and symmetrically across the chip with evanescent field tails. If a particular wavelength component of the incoming light matches the resonant wavelength of one of the resonators ([3-14] in the diagram although in practice there would be many more), it will couple into the resonator, with the remaining light continuing along the waveguide. As the light passes each resonator, any component of the light with a wavelength matching the resonator wavelength will couple into that resonator. Thus, each resonator selectively couples a part of the incoming light, effectively selecting different wavelengths. The semiconductor material comprising the resonators is chosen so that it absorbs light over a particular wavelength range. Thus, when light enters one of the resonators it is also absorbed producing electron-hole pairs in the resonator. When connected to an external circuit via the electrical contacts (eg. [18]&[19] or [18]&[20]) this forms a current which is proportional to the amount of light present in the resonator. Consequently each resonator acts as a detector sensitive to a specific wavelength and when the signals from each detector are connected to an appropriate circuit a spectrum of the light may be produced. The speed at which the spectra can be recorded is limited only by the electron and hole escape time in the resonators (typically microseconds or less) allowing spectra to be obtained at a rate of up to typically 1 million per second.

### INDUSTRIAL APPLICABILITY

The disclosed semiconductor chip provides a spectrophotometer with low mass & low power requirement, cosmic ray-resistant, thermally stable, vibration-resistant, atomic oxygen immune, space vacuum-compatible, and, with no moving parts, the chip would be maintenance free. Thus this spectrophotometer is ideally suitable for hyperspectral imaging for earth observation (for example climate & atmospheric monitoring) and space observation, security monitoring & surveillance, chemical analysis, remote sensing and imaging applications across environmental, healthcare (including ‘wearable’ monitoring systems for healthcare/medical devices), industrial and security markets. Hyperspectral imaging using this spectrophotometer can be performed from space using a linear array of spectrophotometer chips, as each chip can provide broadband spectral information. Current approaches which utilize CCD detectors have a typical integration time of ˜7 ms allowing a ground pixel size of about 50 m. In conventional imaging systems, a 2D silicon CCD array is used with one dimension providing spatial information and the other offering spectral information. A faster acquisition time offers the potential to enhance the special resolution window on the earth (ground pixel size). In our concept a linear array of spectrophotometer chips provides both the spectral and special information. In applications demanding high resolution, each resonator would be used to target a specific wavelength. The resolution of this approach is linked to the resonator size for which we expect to be able to achieve a resolution of ˜1 nm using current technology. For applications where speed is more important than resolution, multiple microdisks (resonators) can be coupled together to cover a wider wavelength region with faster data acquisition or data from specific resonators may not be detected thereby reducing the data collection time. Thus the spectrophotometer may be dynamically tuned on the fly to optimise either acquisition time or resolution. For example the spectrophotometer settings may be changed from covering a spectral range of 1000 nm to 2000 nm at 1 nm resolution (1000 data points) to covering the same range but with lower resolution, for example coupling groups of 10 resonators together to provide a resolution of 10 nm but a much faster data collection rate. This can be controlled remotely and reconfigured depending on the demands of a particular application. The acquisition time is limited by the transient time for the photo generated electrons to exit the chip and is anticipated to be less than 1 ms. Advantageously such a system would also not require the use of mirrors and gratings which age badly in space due to cosmic radiation and decrease the acquisition time. This system, using resonator technology, exploits optically efficient direct band gap semiconductor alloys, such as those in the III-V family.

It is therefore highly attractive to produce a monolithic solution which targets different wavelength windows each of which can be configured to have a dynamically alterable resolution. This offers the flexibility to selectivity ‘on the fly’ meet the requirements for small ground pixel size or high spectral resolution.

Such a spectrophotometer could also be used for example in a digital camera apparatus to replace the currently available colour sensors with sensors (the spectrophotometer chip) to take images in true colour. In addition the spectrophotometer chips could be used for ensuring true colour calibration of TVs (measuring the spectral irradiance and lux levels). Advantageously such a spectrophotometer could be of a coarse resolution nature and used to define visible light perception with a resolution of around 5 nm.

This invention is an alternative to traditional imaging techniques which are based either on the use of detectors with filter windows to offer basic wavelength selectivity over a wide spectral range (with resultant low resolution) or a spectroscopic approach using FTIR or grating-based instruments. The latter are complex systems, some with high maintenance mechanical moving parts and slow data acquisition, all with stray light issues and a large number of discrete optical components. Each additional component introduced into an optical system creates a loss of photons and so reduces signal intensity. Consequently, the development of a monolithic system where a resonator provides both wavelength dispersion and detection capabilities will deliver improved signal intensity, no moving parts, no grating-detector alignment or stray light issues together with a fast acquisition time and high resolution.

It is envisaged that such a spectrophotometer will have a resolution of ˜1 nm and a fast acquisition time of ˜1 ms and can be developed across the visible to infra-red spectral range, with a bandwidth of ˜1000 nm.

This invention concerns a tunable broadband monolithic semiconductor spectrophotometer chip which integrates wavelength separation and detection capabilities within a solid state optical circuit. Wavelength separation and detection take place without the need for moving or spatially separated parts and since everything is embedded on a single, robust chip stray light is minimized whilst light intensity is maximized.

The invention can work across a large bandwidth of wavelengths. The bandwidth used will depend in part upon the composition of the semiconductors used. However, preferably the spectrophotometer is designed to work in the vis-NIR bandwidth from 400 nm to 2000 nm and allows for flexibility of wavelength range/resolution within that bandwidth. For the design of a spectrophotometer in the near IR region (900 nm to 1700 nm) alloys based upon group III-V compound semiconductors are preferably used as the optical properties of III-V semiconductor alloys are well known.

Although the approach may be utilized with silicon, III-Vs alloys are more optically active and cover a larger wavelength range. Typical materials include AlInGaN alloys for short wavelength spectroscopy, AlGaInAsP alloys for the visible range, and InGaAsP, InGaAsN and InGaAlAsSb alloys for the near- and mid-infrared. The wavelength range of the chip can therefore be tailored through judicious use of different semiconductor alloys. In addition, the introduction of impurities, e.g. Zn, C, Te into the alloy can provide fine tuning of the optical and electronic properties of the chip and components thereof.

Core Semiconductor Design

The spectrophotometer chip is almost entirely semiconductor based, with the semiconductor alloy forming both the optical waveguide for incoming light and the resonators where the light is detected. The waveguide is formed from bulk semiconductor material where the alloy is designed such that its band gap is larger than the energy of the highest energy (shortest wavelength) photons of interest. The resonator is formed from a semiconductor multilayer with a bulk or quantum well active region forming the core absorbing region such that the optical gap of the active region is greater than or equal to than the smallest energy (longest wavelength) photons. Thus, the exact compositions and doping of the semiconductor alloys is determined for a specific target wavelength range, taking into account the electrical, optical and thermal characteristics of the materials.

Waveguide and Resonator Structure

The waveguide may consist of an angled rib-waveguide. This is to prevent back reflection from the end facets of the spectrophotometer chip. The height and width of the waveguide is optimized to allow maximum throughput of light into the spectrophotometer. As shown in FIGS. 1 to 3, the cylindrical resonator will be closely coupled to the waveguide to allow evanescent leakage of the light into each resonator. Since each resonator targets a specific wavelength, the diameter, thickness and spacing relative to the waveguide is optimised to maximize light coupling efficiency and to minimize stray light. As a general design rule, the resonator diameter (D) will be designed such that D=(wavelength*m/Pi*n) wherein n is the effective refractive index of the semiconductor and m is the resonator order. Thus for a resonator sensitive to 1.5 μm radiation, operating in second order, with a typical refractive index of 3.2 the diameter D is 300 nm. This is well within the capabilities of ultraviolet or e-beam lithography techniques.

Tolerances<20 nm are feasible using electron-beam or deep UV lithography. At the prototyping stage it is envisaged that electron-beam lithography would be used since it is extremely versatile and current technology is much better for attempting multiple designs on one wafer. In a production phase, electron-beam is also possible, however, deep-UV and holographic lithography techniques are much quicker at producing large numbers of devices with such tolerances.

Optical Coatings

The front and back facets of the spectrophotometer chip are optionally coated with a coating to allow the spectrophotometer chip to work in a higher order, for example, 1st, 2nd or 3rd, 81st order and so on. This is a desirable feature as it will allow operation with larger resonators, therefore making manufacturing simpler. The precise composition, thickness and refractive index of the layers is optimised to match the wavelength range of interest. The coating will typically consist of a number of di-electric layer pairs chosen so that their total optical thickness is resonant over a particular wavelength range (pass-band). Alternatively, a nano-scale particulate coating may be used to resonantly couple light of particular wavelengths into the chip.

Electrical Coupling

The photo-generated electrons from the spectrometer chip form an electrical current that provides the spectral intensity information. In order to extract the current, a p-n junction is utilized, which when biased with a voltage provides an electric field to sweep the electrons out of the device.

Wavelength Range

As stated above the wavelength range of the spectrophotometer chip is determined by the semiconductor materials from which it is composed. For a spectrophotometer operating in the near IR applications over a wavelength range of 900 nm-1700 nm, existing approaches to achieve this range utilise cooled InGaAs detectors. Efficient multiple quantum well absorbing region based on InGaAs(P)/InP alloys could also be used. However, spectrophotometer chips operating in different wavelength ranges are envisaged with judicious combinations of semiconductor material, doping and resonator size.

Mass and Footprint

The spectrophotometer chip itself will have a negligible mass. Assuming an InP based chip with dimensions of 1 mm×250 microns×200 microns, for which the density of InP is 4.8 g/cm³, the chip mass is 24 micrograms. Thus the main mass of the spectrophotometer will be the associated micro optics (<100 g). The equivalent mass of a typical CCD based spectrophotometer excluding optics is substantially higher. The typical dimensions of a CCD system are in the region of 5 cm×10 cm×15 cm. In conventional spectrophotometers, the resolution is limited by the size of the box (to maximize dispersion). In this invention, the resolution is intrinsically linked to the wavelength of the light meaning that the spectrophotometer can be extremely small.

The claims as filed form part of the description.

1) A spectrophotometer comprising a monolithic semiconductor substrate (1), one or more wavelength dispersing means (3-14), and one or more wavelength detecting means (3-14), characterised in that the dispersing means (3-14) and detecting means (3-14) is a micro-resonator (3-14).

2) The spectrophotometer according to claim 1, characterised in that the dispersing means (3-14) and detecting means (3-14) have no physically moving parts.

3) The spectrophotometer according to claim 2, characterised in that each microresonator (3-14) is sized to optimally accept a wavelength of light or plurality of wavelengths of light in that the diameter (D) of each resonator is determined by the formula D=nλ/πμ.

4) The spectrophotometer according to any one of claim 3, characterised in that each micro-resonator acts as a detector of the level of light of a particular wavelength.

5) The spectrophotometer according to claim 4, characterised in that the spectrophotometer contains one or more waveguide means (2).

6) The spectrophotometer according to claim 5, characterised in that each resonator (3-14) forms part of the waveguide means (2), or each resonator (3-14) is optimally positioned in proximity to the waveguide means (2).

7) The spectrophotometer according to claim 4, characterised in that the resonator (3-14) is spherical, conical, stepped conical, tabulate, cylindrical cupped or comprises one or more flat or curved surfaces.

8) The spectrophotometer according to claim 4, characterised in that the substrate comprises silicon or a III-V semiconductor onto which group III-V semiconductor alloy based layers are added

9) The spectrophotometer according to claim 8, characterised in that the substrate is doped either p- or n-type.

10) The spectrophotometer according to claim 4 or claim 8 or claim 9, characterised in that the substrate is divided into three functional regions, wherein the first region is a substrate layer (17) made from a semi-conductor doped either p- or n-type, the second region (16) comprising of a semi-conductor in which a band gap is incorporated to cover the wavelength range of the spectrophotometer and has a refractive index greater than that of the substrate, and the third optical cladding region (18) having a lower refractive index than the second region (16), wherein the second region (16) is positioned between the first region (17) and the third region (18).

11) The spectrophotometer according to claim 10, characterised in that the third region (18a) is a common electrical contact with the first region (17).

12) The spectrophotometer according to claim 11, characterised in that the resonators (3-14) have electrical contacts (19, 20) on their surfaces.

13) The spectrophotometer according to claim 4, characterised in that the facets of the chip may be coated with substances to accept or reject light over a particular wavelength range.

14) The spectrophotometer according to claim 4, characterised in the substrate may comprise one or more solid state shutters or light guiding optics.

15) A spectrophotometer comprising a monolithic semiconductor, comprising one or more wavelength dispersing means (3-14), and one or more wavelength detecting means (3-14), characterised in that the dispersing means (3-14) and detecting means (3-14) is a micro-resonator (3-14), further characterised in that the monolithic semiconductor (1) is a semi conductor having a waveguide means (2) and one or more resonators (3-14), each resonator (3-14) is optimally positioned in proximity to the waveguide means (2), the resonators are optimally dimensioned for a given electromagnetic wavelength, the substrate is divided into three functional regions, wherein the first region is a substrate layer (17) made from a semiconductor doped either p- or n-type, the second active region (16) comprising of a semiconductor in which a band gap is incorporated to cover the wavelength range of the spectrophotometer and has a refractive index greater than that of the substrate, and the third optical cladding region (18) having a lower refractive index than the second active region (16), wherein the second active region (16) is positioned between the first region (17) and third region (18), a further region (18a) is a common electrical contact with the first region (17), and the resonators (3-14) have electrical contacts (19, 20) on their surfaces.
